(19) United States
(12) Patent Application Publication
(10) Pub. No.: US 2025/0205896 A1
(43) Pub. Date: Jun. 26, 2025

(54) REMOTE OPERATION CONTROL DEVICE, REMOTE OPERATION CONTROL METHOD, AND STORAGE MEDIUM

(71) Applicant: HONDA MOTOR CO., LTD., Tokyo (JP)

(72) Inventor: Itoshi Naramura, Wako-shi (JP)

(21) Appl. No.: 18/981,744

(22) Filed: Dec. 16, 2024

(30) Foreign Application Priority Data
Dec. 26, 2023 (JP) 2023-219221

(51) Int. Cl. B25J 9/16; B25J 13/02; B25J 13/08

(52) U.S. Cl. CPC B25J 9/1694; B25J 13/02; B25J 13/088; B25J 13/089

(57) ABSTRACT

A remote operation control device includes an intention estimation unit estimating a motion of an operator on the basis of a first sensor value obtained by an environmental sensor acquiring information of a robot or a surrounding environment of the robot, and a second sensor value indicating movement of the operator obtained by an operator sensor; a relationship acquisition unit acquiring a relationship between a first operation target object and a second target object, and a control command generation unit generating a control command on the basis of an estimated motion of the operator and information acquired by the relationship acquisition unit.

### CROSS-REFERENCE TO RELATED APPLICATION

Priority is claimed on Japanese Patent Application No. 2023-219221, filed Dec. 26, 2023, the content of which is incorporated herein by reference.

### BACKGROUND OF THE INVENTION

### Field of the Invention

The present invention relates to a remote operation control device, a remote operation control method, and a storage medium.

### Description of Related Art

In order to perform a remote operation of a robot having a multiple-finger hand (including two fingers) through a non-exoskeletal control interface, a trajectory of the robot is restricted in accordance with an operation determined for each object, and therefore operability is improved.

For example, according to the technology described in the following Patent Document 1, in a robot remote operation of operating a robot by recognizing movement of an operator and transferring the movement of the operator to the robot, an intention estimation unit estimates a motion of the operator on the basis of a robot environmental sensor value obtained by an environmental sensor installed in the robot or a surrounding environment of the robot, and an operator sensor value indicating movement of the operator obtained by an operator sensor, and a control command generation unit generates a control command with which a degree of freedom in motion of the operator is reduced by generating a control command appropriate for a degree of freedom in part of the motion of the operator on the basis of an estimated motion of the operator.

[Patent Document 1] Japanese Unexamined Patent Application, First Publication No. 2022-157101

### SUMMARY OF THE INVENTION

However, the technology in the related art has a problem of difficulty in remote operation of handling a plurality of objects.

Aspects according to the present invention have been made in consideration of the foregoing problems, and an object thereof is to provide a remote operation control device, a remote operation control method, and a storage medium capable of handling a plurality of objects.

In order to resolve the foregoing problems and achieve the object, the present invention employs the following aspects.

(1) A remote operation control device according to an aspect of the present invention, in a robot remote operation of operating a robot by recognizing movement of an operator and transferring the movement of the operator to the robot, includes an intention estimation unit estimating a motion of the operator on the basis of a first sensor value obtained by an environmental sensor acquiring information of the robot or a surrounding environment of the robot, and a second sensor value indicating movement of the operator obtained by an operator sensor; a relationship acquisition unit acquiring a relationship between a first operation target object and a second target object; and a control command generation unit generating a control command on the basis of an estimated motion of the operator and information acquired by the relationship acquisition unit.

(2) The foregoing aspect (1) may further include a robot whole body joint angle estimation unit estimating a joint angle of the whole body of the robot on the basis of a finger joint angle and a wrist posture of the operator included in the second sensor value. The control command generation unit may generate a control command also using an estimated joint angle of the whole body of the robot.

(3) The foregoing aspect (1) or (2) may further include an object posture estimation unit estimating a posture of each of the first operation target object and the second target object on the basis of the first sensor value. The control command generation unit may generate a control command also using an estimated posture of each of the first operation target object and the second target object.

(4) According to any one of the foregoing aspects (1) to (3), the control command generation unit may generate a control command with which a degree of freedom in motion of the operator is reduced by generating a control command appropriate for a degree of freedom in part of the motion of the operator.

(5) According to any one of the foregoing aspects (1) to (4), the second target object may be an object having a relationship with the first operation target object in operation.

(6) According to any one of the foregoing aspects (1) to (5), when there are a plurality of the operation target objects, the relationship acquisition unit may acquire relationship information from a database in which a relationship between the operation target objects or between the operation target objects and a surrounding environment is described in advance using information identifying the target objects from the first sensor value.

(7) According to any one of the foregoing aspects (1) to (6), the relationship acquisition unit may extract an appearance feature amount and a geometric feature amount for each of the operation target objects using identification information related to an object, a position and a size of a region of interest, and a luminance within the region of interest detected using an image and included in the first sensor value, acquire a relationship between the first operation target object and the second target object using the appearance feature amount and the geometric feature amount extracted for each of the operation target objects, and output the relationship in text.

(8) The foregoing aspect (1) may further include a robot whole body joint angle estimation unit estimating a joint angle of the whole body of the robot on the basis of a finger joint angle and a wrist posture of the operator included in the second sensor value, and an object posture estimation unit estimating a posture of each of the first operation target object and the second target object on the basis of the first sensor value. The relationship acquisition unit may extract an appearance feature amount and a geometric feature amount for each of the operation target objects using identification information related to an object, a position and a size of a region of interest, and a luminance within the region of interest detected using an image and included in the first sensor value, acquire a relationship between the first operation target object and the second target object using the appearance feature amount and the geometric feature amount extracted for each of the operation target objects, and output the relationship in text. The control command generation unit may generate a first feature vector by encoding a set of an estimated motion of the operator, an estimated joint angle of the whole body of the robot, and an estimated posture of each of the first operation target object and the second target object, generate a second feature vector by encoding text output by the relationship acquisition unit, and generate a control command that is a joint angle trajectory sequence of the robot by associating the first feature vector and the second feature vector with each other and encoding associated data.

(9) A remote operation control method according to another aspect of the present invention is a remote operation control method for operating a robot remote operation of operating a robot by recognizing movement of an operator and transferring the movement of the operator to the robot. The remote operation control method includes estimating a motion of the operator by the intention estimation unit on the basis of a first sensor value obtained by an environmental sensor acquiring information of the robot or a surrounding environment of the robot, and a second sensor value indicating movement of the operator obtained by an operator sensor; acquiring a relationship between a first operation target object and a second target object by a relationship acquisition unit; and generating a control command by a control command generation unit on the basis of an estimated motion of the operator and information acquired by the relationship acquisition unit.

(10) A storage medium according to another aspect of the present invention stores a program for causing a computer of a remote operation control device, which performs a robot remote operation of operating a robot by recognizing movement of an operator and transferring the movement of the operator to the robot, to estimate a motion of the operator on the basis of a first sensor value obtained by an environmental sensor acquiring information of the robot or a surrounding environment of the robot, and a second sensor value indicating movement of the operator obtained by an operator sensor, to acquire a relationship between a first operation target object and a second target object, and to generate a control command on the basis of an estimated motion of the operator and acquired information of the relationship between the first operation target object and the second target object.

According to the foregoing aspects (1) to (10), since relational information between objects is used, it is possible to handle a plurality of objects. According to the foregoing aspects (1) to (10), since operational restrictions taking relationships between objects into consideration are imposed, operability is improved.

### BRIEF DESCRIPTION OF THE DRAWINGS

FIG. 1 is an explanatory view of an overview of a remote operation of a robot and a target object of an operation.

FIG. 2 is a view showing an example of details of an operation.

FIG. 3 is a view showing an example of a constitution of a remote operation control system according to an embodiment.

FIG. 4 is a view showing processing constitution blocks of a control device according to the embodiment.

FIG. 5 is a view showing an example of a constitution of a detection unit of the embodiment.

FIG. 6 is a view showing an example of a constitution of an inter-object relationship estimation unit of the embodiment.

FIG. 7 is a view showing an example of a constitution of an affordance estimation block of the embodiment.

FIG. 8 is a view showing an example of a constitution of an object posture estimation unit of the embodiment.

FIG. 9 is a view showing an example of a constitution of a robot whole body joint angle estimation unit of the embodiment.

FIG. 10 is a view showing an example of a constitution of a control command generation unit of the embodiment.

FIG. 11 is a flowchart of an example of a processing procedure performed by the remote operation control system according to the embodiment.

### DETAILED DESCRIPTION OF THE INVENTION

Hereinafter, an embodiment of the present invention will be described with reference to the drawings. In the drawings used in the following description, the scale of each member has been suitably changed so that each member has a recognizable size.

In all explanatory drawings for the embodiment, the same reference signs are used for those having the same function, and duplicate description will be omitted.

In this application, the expression “on the basis of XX” denotes “on the basis of at least XX” and also includes cases based on other elements in addition to XX. The expression “on the basis of XX” is not limited to cases of directly using XX and also includes cases based on computation or processing performed with respect to XX. “XX” is an arbitrary element (for example, arbitrary information).

### [Overview of Remote Operation and Target Object of Operation]

First, an overview of a remote operation and a target object of an operation will be described.

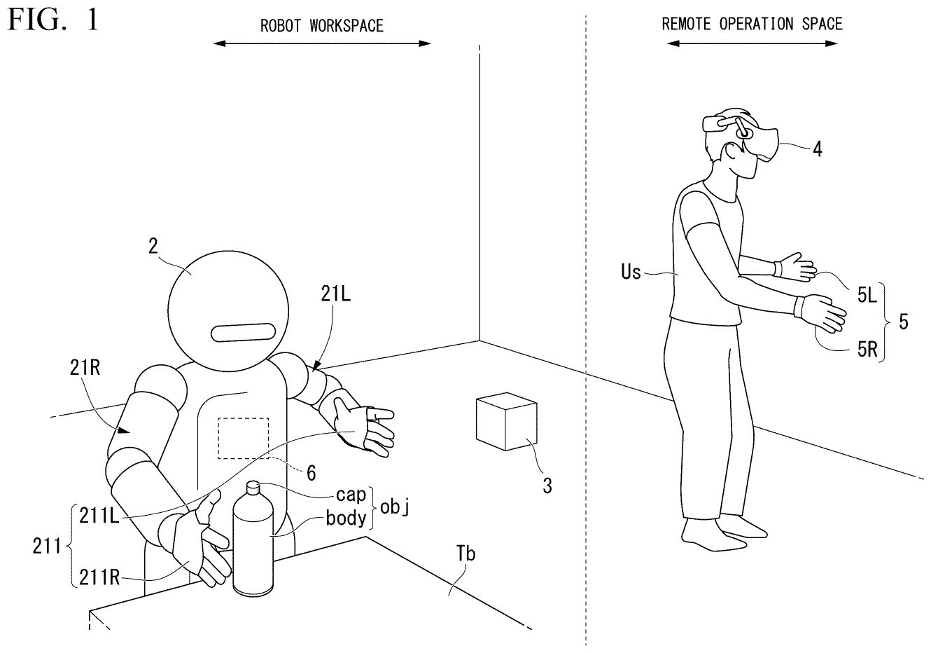

FIG. 1 is an explanatory view of an overview of a remote operation of a robot and a target object of an operation. As in FIG. 1, in a remote operation space, for example, an operator Us wears a head-mounted display (HMD) 4 on the head and wears operation units 5 (5L, 5R) such as data gloves on the hands. An environmental sensor 3 is installed in a robot workspace. The environmental sensor 3 may be attached to a robot 2. The robot 2 includes a control device 6, end effectors 21 (a first end effector 21L and a second end effector 21R), and hands 211 (211L and 211R).

A target object obj is constituted of a plurality of objects. For example, the target object obj is a plastic bottle or a bottle and includes a body and a cap.

For example, the operator Us moves the hands and the fingers wearing the operation units 5 while watching images displayed in the HMD 4 to operate the target object obj by remotely operating the robot 2.

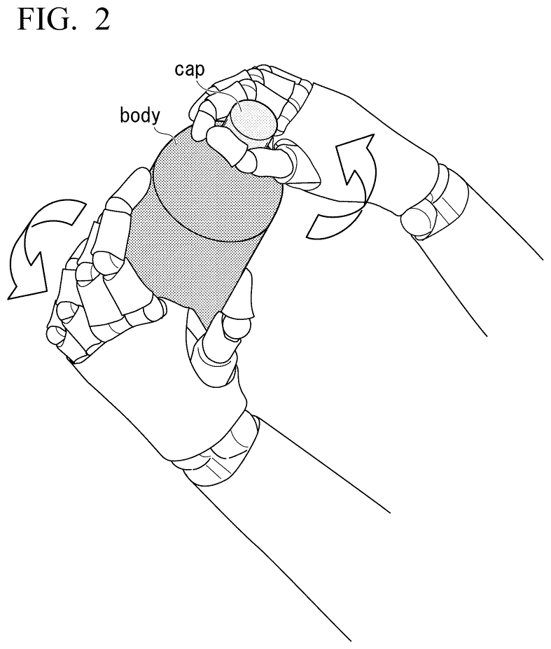

As in FIG. 2, an example of details of an operation is to attach the cap to the body and close it, to open the cap from the body, or the like. FIG. 2 is a view showing an example of details of an operation.

However, when a plurality of objects are operated, the operation method is not decided unless relationships between objects are not taken into consideration. As a result, no restriction method can be determined.

Here, an example of a relationship between a plurality of objects when a plurality of objects are handled will be described.

For example, when a cap of a plastic bottle is closed, constraint conditions on a receptor side can be determined only from the plastic bottle, and constraint conditions on a connector side can be determined from only the cap. Therefore, they become meaningful operational restrictions only by superimposing these two restricting conditions.

### [Constitution of Remote Operation Control System]

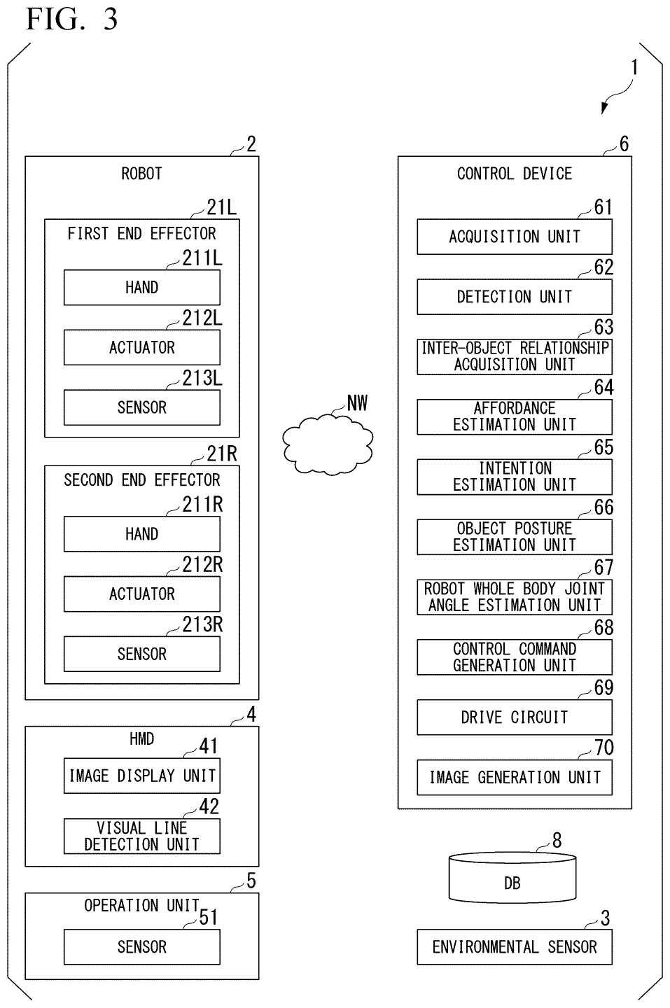

Next, an example of a constitution of a remote operation control system 1 will be described. FIG. 3 is a view showing an example of a constitution of a remote operation control system according to the present embodiment.

As in FIG. 3, for example, the remote operation control system 1 includes the robot 2, the environmental sensor 3, the HMD 4, the operation units 5, the control device 6 (remote operation control device), and a DB 8.

For example, the robot 2 includes the first end effector 21L and the second end effector 21R. For example, the first end effector 21L includes the hand 211L, an actuator 212L, and a sensor 213L. For example, the second end effector 21R includes the hand 211R, an actuator 212R, and a sensor 213R. The robot 2 may include a communication unit (not shown), a power source unit, a body, legs, a head, and the like.

In the following description, when there is no need to distinguish between the first end effector 21L and the second end effector 21R, they will also be referred to as the end effectors 21. Similarly, when there is no need to distinguish between the hand 211L and the hand 211R, they will also be referred to as the hands 211. When there is no need to distinguish between the actuator 212L and the actuator 212R, they will also be referred to as the actuators 212. When there is no need to distinguish between the sensor 213L and the sensor 213R, they will also be referred to as the sensors 213.

The robot 2 transmits and receives various kinds of information with respect to the control device 6 via a wired or wireless network NW.

For example, the HMD 4 includes an image display unit 41 and a visual line detection unit 42. The HMD 4 also includes a communication unit (not shown), a power source unit, and the like.

The HMD 4 transmits and receives various kinds of information with respect to the control device 6 via the wired or wireless network NW.

For example, the operation units 5 each include a sensor 51. The operation units 5 each include a communication unit (not shown). The operation units 5 transmit information to the control device 6 via the wired or wireless network NW.

For example, the control device 6 includes an acquisition unit 61, a detection unit 62, an inter-object relationship acquisition unit 63, an affordance estimation unit 64, an intention estimation unit 65, an object posture estimation unit 66, a robot whole body joint angle estimation unit 67, a control command generation unit 68, a drive circuit 69, and an image generation unit 70. The control device 6 also includes a communication unit (not shown), a power source unit, and the like.

The control device 6 transmits and receives various kinds of information with respect to the robot 2 and the HMD 4 via the wired or wireless network NW. The control device 6 receives various kinds of information from the environmental sensor 3 and the operation units 5 via the wired or wireless network NW.

The example of the constitution shown in FIG. 3 is merely an example, and the constitution is not limited thereto.

### [Function of Each Device in Remote Operation Control System]

Next, using FIG. 3, the function of each device in the remote operation control system will be described.

### (Robot 2)

For example, the hands 211 each include a plurality of finger portions. Each of the finger portions includes joints. The hands 211 may be grippers or the like.

The actuators 212 are attached to the respective joints.

For example, the sensors 213 are six-axis sensors attached to the joints, touch sensors attached to the finger portions, or the like. The six-axis sensors detect forces along three axes (x, y, and z) and moments along three axes (α, β, and γ).

The robot 2 may include a drive circuit for driving the actuators 212.

### (Environmental Sensor 3)

As in FIG. 1, for example, the environmental sensor 3 is installed in the robot workspace. For example, the environmental sensor 3 is an RGB-D camera and acquires RGB (red, green, and blue) information and depth information. For example, information is acquired at predetermined time intervals.

### (HMD 4)

The image display unit 41 displays images output by the control device 6.

The visual line detection unit 42 detects a visual line direction and movement of a visual line of the operator Us.

### (Operation Unit 5)

For example, the operation units 5 are data gloves. The operation units 5 detect finger joint angles and wrist joint angles of the hands of the operator Us.

### (Control Device 6)

The acquisition unit 61 acquires a first sensor value detected by the sensors 213 from the robot 2. The acquisition unit 61 acquires the first sensor value detected by the environmental sensor 3. The acquisition unit 61 acquires a second sensor value detected by the sensors 51 of the operation units 5. The acquisition unit 61 acquires the second sensor value detected by the visual line detection unit 42 of the HMD 4.

The detection unit 62 detects an object using the first sensor value acquired by the acquisition unit 61 and detects point cloud data, an identification information ID for identifying an object, a region of interest (ROI), and a luminance value for each target object. An example of a constitution and an example of processing of the detection unit 62 will be described below in detail.

The inter-object relationship acquisition unit 63 extracts a feature amount for each target object using the identification information ID for identifying an object, the region of interest, and the luminance value detected by the detection unit 62, estimates a relationship between a plurality of target objects, and generates a generative caption. A generative caption is information indicating a relationship between objects in natural language (text), for example. An example of a constitution and an example of processing of the inter-object relationship acquisition unit 63 will be described below in detail.

The affordance estimation unit 64 estimates an affordance using the point cloud data detected by the detection unit 62. An example of a constitution and an example of processing of the affordance estimation unit 64 will be described below in detail.

The intention estimation unit 65 estimates an operational intention of the operator Us using the information indicating an affordance estimated by the affordance estimation unit 64, the visual line information (second sensor value) detected by the HMD 4, and the finger joint angles and the wrist joint angles detected by the operation units 5, and generates a point cloud with affordances.

The object posture estimation unit 66 estimates a posture of each operation object using the point cloud data detected by the detection unit 62. An example of a constitution and an example of processing of the object posture estimation unit 66 will be described below in detail.

The robot whole body joint angle estimation unit 67 estimates whole body joint angles of the robot 2 using the finger joint angles and the wrist joint angles detected by the operation units 5 and generates a joint angle trajectory sequence. For example, whole body joint angles are joint angles of respective joints of the end effectors 21, for example, joint angles of the arms, joint angles of the wrists, joint angles of the finger portions, and the like. An example of a constitution and an example of processing of the robot whole body joint angle estimation unit 67 will be described below in detail.

The control command generation unit 68 generates a control command using the generative caption output by the inter-object relationship acquisition unit 63, the point cloud data with affordances output by the intention estimation unit 65, the joint angle trajectory sequence output by the robot whole body joint angle estimation unit 67, and the information indicating an object posture of each target object output by the object posture estimation unit 66. An example of a constitution and an example of processing of the control command generation unit 68 will be described below in detail.

The drive circuit 69 generates a drive signal for controlling the robot 2 on the basis of the control command generated by the control command generation unit 68.

When the robot 2 includes the drive circuit 69, the control device 6 may not include the drive circuit 69. Alternatively, the control device 6 and the robot 2 may each include a part of the drive circuit 69.

The image generation unit 70 generates images to be provided to the HMD 4 on the basis of images and the like captured by the environmental sensor 3. Regarding a method for generating images to be displayed in the HMD 4 and examples of images, for example, the method described in Japanese Patent Application No. 2022-156322, or the like is used.

The DB 8 is a database and stores results estimated by the affordance estimation unit 64.

### [Processing Constitution Blocks]

Next, processing constitution blocks of the control device 6 will be described.

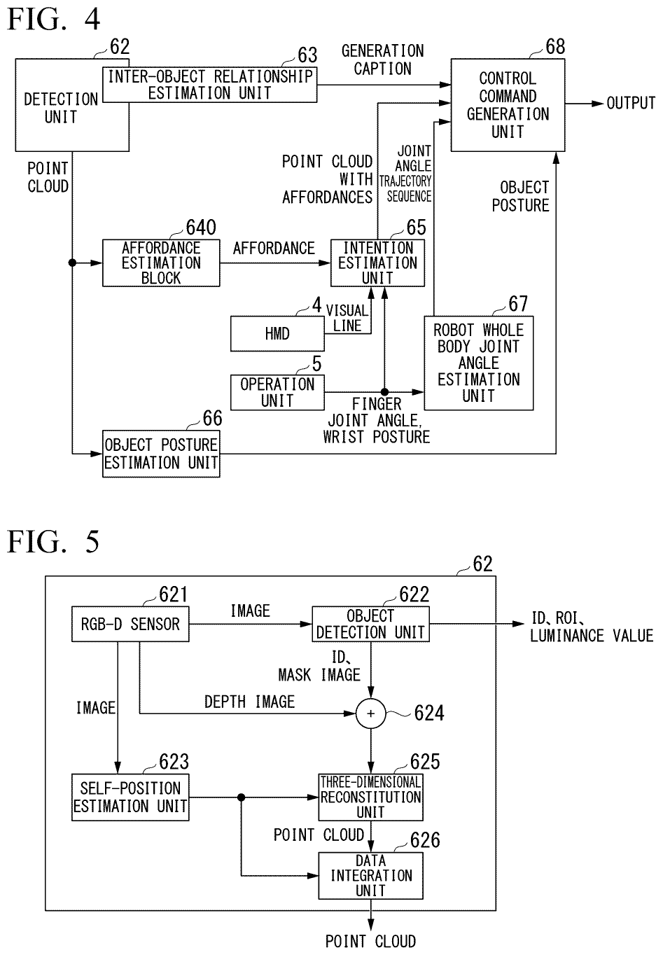

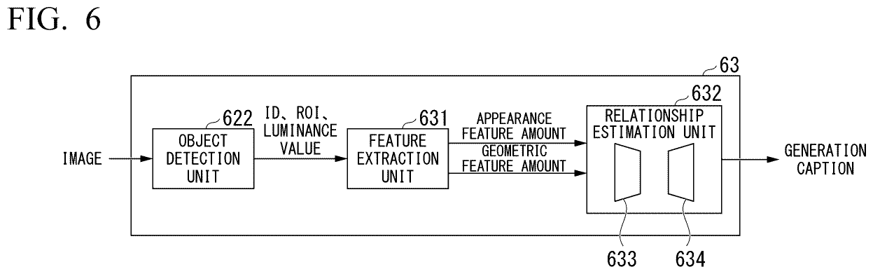

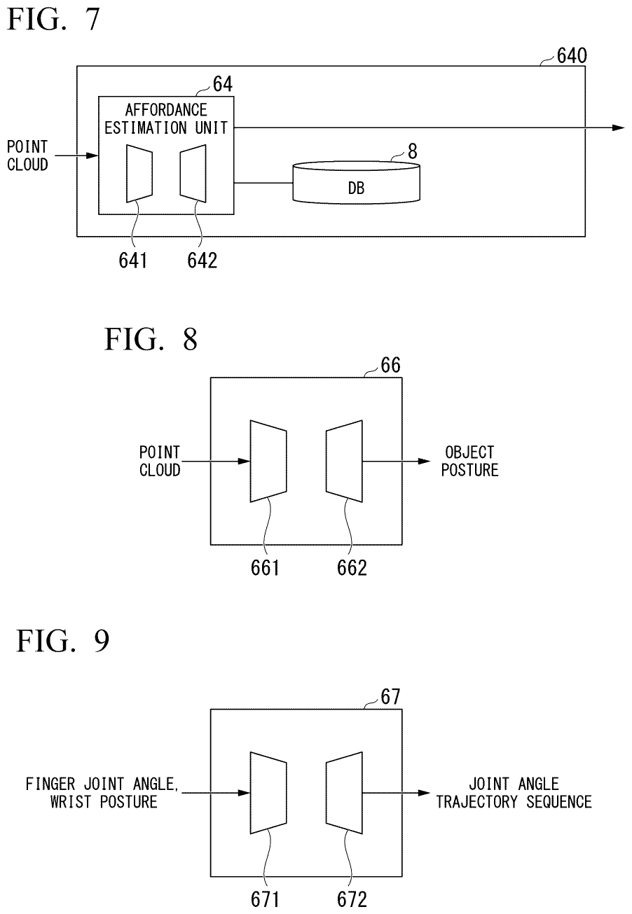

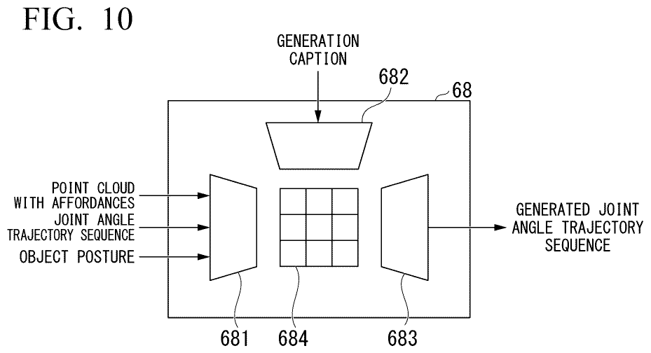

FIG. 4 is a view showing processing constitution blocks of a control device according to the present embodiment. FIGS. 5 to 10 are block diagrams of respective constituents. FIG. 5 is a view showing an example of a constitution of a detection unit of the present embodiment. FIG. 6 is a view showing an example of a constitution of an inter-object relationship estimation unit of the present embodiment. FIG. 7 is a view showing an example of a constitution of an affordance estimation unit of the present embodiment. FIG. 8 is a view showing an example of a constitution of an inter-object relationship estimation unit of the present embodiment. FIG. 9 is a view showing an example of a constitution of a robot whole body joint angle estimation unit of the present embodiment. FIG. 10 is a view showing an example of a constitution of a control command generation unit of the present embodiment.

### (Detection Unit 62)

First, the detection unit 62 will be described using FIGS. 4 and 5.

As in FIG. 5, for example, the detection unit 62 includes an RGB-D sensor 621, an object detection unit 622, a self-position estimation unit 623, an addition unit 624, a three-dimensional reconstitution unit 625, and a data integration unit 626.

For example, the RGB-D sensor 621 corresponds to a sensor included in the environmental sensor 3. The RGB-D sensor 621 acquires RGB images and depth images. For example, images acquired by the RGB-D sensor 621 include a plurality of target objects, the finger portions of the robot, and the like. The RGB-D sensor 621 outputs images to the object detection unit 622 and the self-position estimation unit 623.

The object detection unit 622 performs detection for each object by performing known image processing (for example, binarization, image enhancement, feature amount extraction, contour rendering, clustering processing, or the like) with respect to the images output by the RGB-D sensor 621. The object detection unit 622 outputs the identification information ID, the position and the size of the region of interest ROI, and the luminance value within the ROI in association with each other for each detected object. The object detection unit 622 outputs the identification information ID and a mask image in association with each other to the addition unit 624 for each detected object. The object detection unit 622 detects the region of interest ROI, generates a mask image, and the like through image processing for each detected object. The object detection unit 622 may detect an object, for example, using a model such as a region CNN (R-CNN) that has been pre-trained until the difference between the teaching data and the output is within a predetermined value by inputting an image and teaching data (a set of the identification information ID, the region of interest ROI, and the luminance value for each object and a set of the identification information ID and the mask image for each object) to a model, and outputting the set of the identification information ID, the region of interest ROI, and the luminance value for each object and the set of the identification information ID and the mask image for each object. For example, a selective search technique may be used for detecting the region of interest ROI.

The self-position estimation unit 623 estimates where robot coordinates are present based on a map coordinate system determined in advance, for example, with respect to the image for each object output by the RGB-D sensor 621.

The addition unit 624 combines the identification information ID and the mask image output by the object detection unit 622 with the depth image output by the RGB-D sensor 621 for each object and outputs combined data to the three-dimensional reconstitution unit 625.

The three-dimensional reconstitution unit 625 converts the depth image into a three-dimensional point cloud for reconstitution using the output of the addition unit 624 and positional information for each object output by the self-position estimation unit 623. A reference coordinate system of the point cloud at this time becomes a robot coordinate system (it is assumed that conversion from the sensor coordinate system into the robot coordinate system is performed internally). The point cloud data includes the positional information. The point cloud output by the three-dimensional reconstitution unit 625 is based on the robot coordinates at a time t. For this reason, the three-dimensional reconstitution unit 625 performs coordinate conversion into a point cloud based on map coordinates using “the robot coordinates at the time t based on the map coordinates” output by the self-position estimation unit 623. In the present embodiment, since a point cloud in the map coordinate system is determined regardless of time by performing these steps of processing, data can be integrated by simply adding them up.

The data integration unit 626 integrates the three-dimensionally rebuilt point cloud data output by the three-dimensional reconstitution unit 625 in time series for each object on the basis of the position for each object output by the self-position estimation unit 623. The data integration unit 626 outputs the point cloud data integrated for each object.

### (Inter-Object Relationship Acquisition Unit 63)

Next, the inter-object relationship acquisition unit 63 will be described using FIGS. 4 and 6.

As in FIG. 6, for example, the inter-object relationship acquisition unit 63 includes the object detection unit 622, a feature extraction unit 631, and a relationship estimation unit 632. As in FIG. 6, the inter-object relationship acquisition unit 63 shares the object detection unit 622 with the detection unit 62.

The feature extraction unit 631 extracts an appearance feature amount and a geometric feature amount for each object by a known technique using data of the set of the identification information ID, the region of interest ROI, and the luminance value for each object output by the object detection unit 622.

For example, the relationship estimation unit 632 includes an encoder 633 and a decoder 634. The relationship estimation unit 632 inputs the appearance feature amount and the geometric feature amount for each object output by the feature extraction unit 631 to the pre-trained encoder 633, inputs the output of the encoder 633 to the pre-trained decoder 634, and outputs a generative caption.

In an encoder-decoder model (or a network), an encoder outputs a low-dimensional latent representation, for example, by performing bottom-up encoding processing in order with respect to an input. A decoder performs top-down decoding processing, for example, with respect to the low-dimensional latent representation output by the encoder. For example, the encoder and the decoder are constituted by a network such as a recurrent neural network (RNN) or a convolutional neural network (CNN). For example, the encoder 633 and the decoder 634 perform inputting by adding the teaching data to each input in advance and repeatedly perform training until the difference between the output and the teaching data is within a predetermined value.

The relationship estimation unit 632 is not limited to a encoder-decoder and may be a transformer that is a network architecture connecting an encoder and a decoder in an attention model, for example.

### (Affordance Estimation Block 640)

Next, an affordance estimation block 640 will be described using FIGS. 4 and 7. As in FIG. 7, for example, the affordance estimation block 640 includes the affordance estimation unit 64 and the DB 8.

For example, the affordance estimation unit 64 includes a point cloud encoder 641 and a point cloud decoder 642. The encoder and the decoder may be a network base or may be a transformer. For example, the point cloud encoder 641 and the point cloud decoder 642 perform inputting by adding the teaching data to each input in advance and repeatedly perform training until the difference between the output and the teaching data is within a predetermined value.

The point cloud data for each object output by the detection unit 62 is input to the pre-trained point cloud encoder 641 of the affordance estimation unit 64. The pre-trained point cloud encoder 641 encodes the input point cloud data and outputs a low-dimensional latent representation to the pre-trained point cloud decoder 642. The pre-trained point cloud decoder 642 decodes the input low-dimensional latent representation and outputs affordance estimation results. In the output information, information indicating an estimated affordance is associated with each piece of the input point cloud data. For example, in a case of a body and a cap of a plastic bottle, information related to an affordance is information from which details of an operation, such as attaching the cap to a mouth part of the body and turning and closing, can be obtained from the shape of a target object or the category of a target object.

Further, the affordance estimation unit 64 stores estimation results in the DB 8 and further outputs it to the intention estimation unit 65.

The affordance estimation unit 64 may stop the processing after an affordance is estimated in a series of work.

### (Intention Estimation Unit 65)

Next, the intention estimation unit 65 will be described using FIG. 4.

The information indicating an affordance output by the affordance estimation block 640, the visual line information detected by the HMD 4, and the information of the finger joint angles and the wrist postures output by the operation units 5 are input to the intention estimation unit 65. The information indicating an affordance also includes information related to a target object to be operated. The intention estimation unit 65 estimates an operational intention of the operator Us using the input information. That is, the intention estimation unit 65 estimates which operation is to be performed with respect to each target object. An intention may be estimated using taxonomy (for example, refer to Reference Document 1) or further using the information indicating an affordance based on the method described in Japanese Patent Application No. 2022-008829, for example. In the present embodiment, since there are a plurality of target objects, an operational intention can be appropriately estimated with respect to a plurality of target objects using the information indicating an affordance.

The intention estimation unit 65 may be constituted of an encoder and a decoder that have been pre-trained. The encoder and the decoder may be a network base or may be a transformer. Data output by the intention estimation unit 65 is point cloud data with affordances including an estimated operational intention. For example, point cloud data with affordances is data including affordance information in which parts that are pressed or grabbed are displayed with a higher temperature or affordances are sorted by color when represented as a heat map (for example, refer to Patent Documents 2 and 3). For example, when the target object is a plastic bottle and a cap, the image shows respective affordances for a main body part that is grasped, a drinking spout part where the cap is mounted, and the cap.

Reference Document 1; Thomas Feix, Javier Romero, et al., “The GRASP Taxonomy of Human GraspTypes” IEEE Transactions on Human-Machine Systems (Volume: 46, Issue: 1, February 2016), IEEE, p66-77

Reference Document 2; Yuanzhi Liang, Xiaohan Wang, et al., “MAAL: Multimodality-Aware Autoencoder-based Affordance Learning for 3D Articulated Objects”, ICCV 2023, 2023, p217-227

Reference Document 3; Shuichi Akizuki, Yoshimitsu Aoki, “6DoF Pose Estimation for Similar Objects Using Spatial Relationship of Part-Affordance”, Journal of the Japan Society for Precision Engineering, Vol. 85 (2019) No. 1, the Japan Society for Precision Engineering, 2019

### (Object Posture Estimation Unit 66)

Next, the object posture estimation unit 66 will be described using FIGS. 4 and 8.

As in FIG. 8, for example, the object posture estimation unit 66 includes a point cloud encoder 661 and a point cloud decoder 662. The encoder and the decoder may be a network base or may be a transformer. For example, the point cloud encoder 661 and the point cloud decoder 662 perform inputting by adding the teaching data to each input in advance and repeatedly perform training until the difference between the output and the teaching data is within a predetermined value.

The point cloud data for each object output by the detection unit 62 is input to the pre-trained point cloud encoder 661. The input point cloud data is encoded and, for example, a low-dimensional latent representation is output to the pre-trained point cloud decoder 662. The pre-trained point cloud decoder 662 decodes the low-dimensional latent representation, estimates a posture for each object, and outputs information indicating the estimated posture for each object to the control command generation unit 68. The estimate object posture also includes a time series trajectory of the posture change of each object.

### (Robot Whole Body Joint Angle Estimation Unit 67)

Next, the robot whole body joint angle estimation unit 67 will be described using FIGS. 4 and 9.

As in FIG. 9, for example, the robot whole body joint angle estimation unit 67 includes a point cloud encoder 671 and a point cloud decoder 672. The encoder and the decoder may be a network base or may be a transformer. For example, the point cloud encoder 671 and the point cloud decoder 672 perform inputting by adding the teaching data to each input in advance and repeatedly perform training until the difference between the output and the teaching data is within a predetermined value.

For example, the point cloud encoder 671 and the point cloud decoder 672 estimate a posture of the operator Us from a first-person viewpoint. Moreover, they absorb the dimensional difference between the operator Us and the robot 2, thereby estimating the whole body joint angles of the robot. The information indicating the finger joint angles and the wrist postures is input to the pre-trained point cloud encoder 671 from the operation units 5. The pre-trained point cloud encoder 671 encodes the input information and outputs a low-dimensional latent representation, for example, to the pre-trained point cloud decoder 672. The information indicating the finger joint angles and the wrist postures includes information for each of the left and right hands of the operator Us. The pre-trained point cloud decoder 672 estimates a joint angle trajectory sequence by decoding a low-dimensional latent representation and outputs the estimated joint angle trajectory sequence data to the control command generation unit 68.

In the technology in the related art, it has been proposed that joint angles of a person be estimated using a first-person viewpoint of the person, but it has not been possible to estimate whole body joint angles of the robot 2. In contrast, in the present embodiment, the whole body joint angles of the robot 2 are estimated using movement of the fingers and the wrists of the operator Us.

### (Control Command Generation Unit 68)

Next, the control command generation unit 68 will be described using FIGS. 4 and 10.

As in FIG. 10, for example, the control command generation unit 68 includes a motion encoder 681, a text encoder 682, and a motion decoder 683.

The affordance point cloud data, the joint angle trajectory sequence, the information indicating an object posture are input to the motion encoder 681. The motion encoder 681 encodes the input data and outputs a low-dimensional latent representation, for example.

The generative caption is input to the text encoder 682. The text encoder 682 encodes the input generative caption and outputs a low-dimensional latent representation, for example.

For example, the motion encoder 681, the text encoder 682, and the motion decoder 683 perform inputting by adding the teaching data to each input in advance and repeatedly perform training until the difference between the output and the teaching data is within a predetermined value.

For example, the control command generation unit 68 may use contrastive language-image pre-training (CLIP) of OpenAI as a base.

A matrix 684 is generated using feature vectors that are low-dimensional latent representations respectively encoded by the motion encoder 681 and the text encoder 682.

The motion decoder 683 estimates and outputs a joint angle trajectory sequence generated by decoding the feature amount of each of the motion encoder 681 and the text encoder 682. In this manner, in the present embodiment, by associating the generative caption with motion information (affordances, joint angle trajectory sequences, and object postures), it is possible to generate a joint angle command enabling appropriate control of a plurality of objects.

With this constitution, the control device 6 can generate a joint angle command for the robot 2 indicating how a certain object should be operated. The control device 6 may use a generated joint angle command as a restriction and can control motion of the robot 2 using the generated joint angle command. When the generated joint angle trajectory sequence is used as a restriction, for example, the control command generation unit 68 may generate a control command with which the degree of freedom in motion of the operator is reduced by generating a control command appropriate for the degree of freedom in part of the motion of the operator Us.

### Example of Processing Procedure

Next, an example of a procedure of processing performed by the remote operation control system 1 will be described.

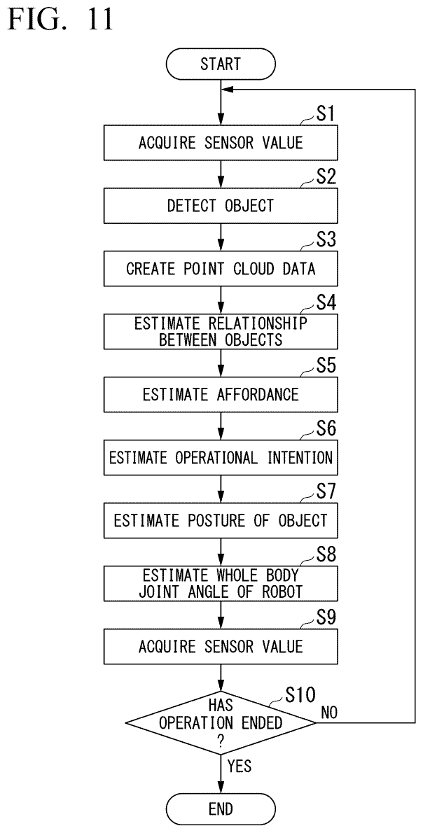

FIG. 11 is a flowchart of an example of a processing procedure performed by the remote operation control system according to the present embodiment.

(Step S1) The acquisition unit 61 acquires the first sensor value detected by the sensors 213. The acquisition unit 61 acquires the first sensor value detected by the environmental sensor 3. The acquisition unit 61 acquires the second sensor value detected by the sensors 51. The acquisition unit 61 acquires the second sensor value detected by the visual line detection unit 42.

(Step S2) The detection unit 62 detects an object using the first sensor value acquired by the acquisition unit 61 and detects the identification information ID, the position and the size of the region of interest ROI, the luminance value in the region of interest ROI for each target object.

(Step S3) The detection unit 62 detects an object using the first sensor value acquired by the acquisition unit 61 and generates three-dimensional point cloud data in time series for each target object.

(Step S4) The inter-object relationship acquisition unit 63 extracts a feature amount for each target object using the identification information ID for identifying an object, the region of interest, and the luminance value detected by the detection unit 62, estimates a relationship between a plurality of target objects, and generates a generative caption.

(Step S5) The affordance estimation unit 64 estimates an affordance using the point cloud data detected by the detection unit 62.

(Step S6) The intention estimation unit 65 estimates an operational intention of the operator Us using the information indicating an affordance, the visual line information (second sensor value), and the finger joint angles and the wrist joint angles, and generates a point cloud with affordances.

(Step S7) The object posture estimation unit 66 estimates a posture of each operation object using three-dimensional point cloud data.

(Step S8) The robot whole body joint angle estimation unit 67 estimates whole body joint angles of the robot 2 using the finger joint angles and the wrist joint angles detected by the operation units 5 and generates a joint angle trajectory sequence.

(Step S9) The control command generation unit 68 generates a control command using the generative caption, the point cloud data with affordances, the joint angle trajectory sequence, and the information indicating an object posture of each target object.

(Step S10) The control command generation unit 68 discriminates whether or not a remote operation by the operator Us has ended. The end of a remote operation may be indicated by the operator Us manually performing a predetermined motion, may be performed by a predetermined eye movement such as blinking, or may be performed by turning off a power source switch included in the HMD 4. When the remote operation has ended (Step S10; YES), the control command generation unit 68 ends the processing. When the remote operation has not ended (Step S10; NO), the control command generation unit 68 returns the processing to Step S1.

The processing procedure that has been described using FIG. 11 is merely an example, and it is not limited thereto. For example, the control device 6 may perform several steps of processing simultaneously or in parallel.

In the example described above, an example of estimating an operational intention has been described, but it is not limited thereto. For example, when there is one correspondence, instead of a plurality of correspondences, between a relationship and an operation method, an operational intention may not be estimated. In this case, the affordance estimation block 640 may be output to the control command generation unit 68.

As above, in the present embodiment, in addition to affordances unique to objects, relationships between objects or between an object and the environment are described in advance, or relationships between objects are obtained via captions from images using a large-scale language model or the like. Since relationships between objects and operation methods often correspond on a one-to-one basis, “operation method=restricting conditions” is obtained by performing searching with the relationship as a key. In the present embodiment, when there are a plurality of correspondences between relationships and operation methods, a determination is made using estimation results of the operational intention of the operator Us. Further, in the present embodiment, an operational input of a person is converted into a robot trajectory sequence and is output within a range satisfying these restricting conditions.

Accordingly, according to the present embodiment, since operational restrictions taking relationships between objects into consideration are imposed, operability is improved.

In the example described above, as an example of a plurality of objects, a plastic bottle and a cap have been described as an example, but it is not limited thereto. For example, a plurality of objects may be “a screw and a member to which the screw is attached”, “a case having a complicated shape and an object stored in the case”, and the like. The number of a plurality of objects may be three or more.

That is, in the embodiment, “a plurality of objects” is not limited to target objects and may be a target object and the surrounding environment (for example, a table, a pedestal, a case, the floor, a wall, ground, a ceiling, or the like) of the target object.

A program for realizing all or some of the functions of the control device 6 according to the present invention may be recorded in a computer-readable storage medium, and all or a part of the processing performed by the control device 6 may be performed by causing a computer system to read and execute the program recorded in this storage medium. Here, the said “computer system” includes an OS and hardware such as peripheral devices. The “computer system also includes a WWW system having a homepage providing environment (or display environment). The “computer-readable storage medium” indicates a portable medium such as a flexible disk, a magneto-optical disk, a ROM, or a CD-ROM, or a storage device such as a hard disk built into the computer system. Moreover, the “computer-readable storage medium” also includes those retaining a program for a certain period of time, such as a server or a volatile memory (RAM) inside the computer system serving as a client when the program is transmitted via a network such as the Internet or a communication line such as a telephone line.

The foregoing program may be transmitted to other computer systems via a transmission medium or by transmission waves in a transmission medium from a computer system in which this program is stored in a storage device or the like. Here, the “transmission medium” for transmitting the program indicates a medium having a function of transmitting information, for example, a network (communication network) such as the Internet or a communication channel (communication line) such as a telephone line. The foregoing program may be a program for realizing some of the functions described above. Moreover, it may be a so-called differential file (differential program) that can realize the functions described above in combination with a program that has already been recorded in the computer system.

Hereinabove, forms for carrying out the present invention have been described using the embodiment. However, the present invention is not limited to such an embodiment in any way, and various deformations and replacements can be added within a range not departing from the gist of the present invention.

What is claimed is:

1. A remote operation control device, in a robot remote operation of operating a robot by recognizing movement of an operator and transferring the movement of the operator to the robot, the device comprising:
an intention estimation unit estimating a motion of the operator on the basis of a first sensor value obtained by an environmental sensor acquiring information of the robot or a surrounding environment of the robot, and a second sensor value indicating movement of the operator obtained by an operator sensor;
a relationship acquisition unit acquiring a relationship between a first operation target object and a second target object; and
a control command generation unit generating a control command on the basis of an estimated motion of the operator and information acquired by the relationship acquisition unit.

2. The remote operation control device according to claim 1 further comprising:
a robot whole body joint angle estimation unit estimating a joint angle of the whole body of the robot on the basis of a finger joint angle and a wrist posture of the operator included in the second sensor value,
wherein the control command generation unit generates a control command also using an estimated joint angle of the whole body of the robot.

3. The remote operation control device according to claim 1 further comprising:
an object posture estimation unit estimating a posture of each of the first operation target object and the second target object on the basis of the first sensor value,
wherein the control command generation unit generates a control command also using an estimated posture of each of the first operation target object and the second target object.

4. The remote operation control device according to claim 1,
wherein the control command generation unit generates a control command with which a degree of freedom in motion of the operator is reduced by generating a control command appropriate for a degree of freedom in part of the motion of the operator.

5. The remote operation control device according to claim 1,
wherein the second target object is an object having a relationship with the first operation target object in operation.

6. The remote operation control device according to claim 1,
wherein when there are a plurality of the operation target objects, the relationship acquisition unit acquires relationship information from a database in which a relationship between the operation target objects or between the operation target objects and a surrounding environment is described in advance using information identifying the target objects from the first sensor value.

7. The remote operation control device according to claim 1,
wherein the relationship acquisition unit extracts an appearance feature amount and a geometric feature amount for each of the operation target objects using identification information related to an object, a position and a size of a region of interest, and a luminance within the region of interest detected using an image and included in the first sensor value, acquires a relationship between the first operation target object and the second target object using the appearance feature amount and the geometric feature amount extracted for each of the operation target objects, and outputs the relationship in text.

8. The remote operation control device according to claim 1 further comprising:
a robot whole body joint angle estimation unit estimating a joint angle of the whole body of the robot on the basis of a finger joint angle and a wrist posture of the operator included in the second sensor value; and
an object posture estimation unit estimating a posture of each of the first operation target object and the second target object on the basis of the first sensor value,
wherein the relationship acquisition unit extracts an appearance feature amount and a geometric feature amount for each of the operation target objects using identification information related to an object, a position and a size of a region of interest, and a luminance within the region of interest detected using an image and included in the first sensor value, acquires a relationship between the first operation target object and the second target object using the appearance feature amount and the geometric feature amount extracted for each of the operation target objects, and outputs the relationship in text, and
the control command generation unit
generates a first feature vector by encoding a set of an estimated motion of the operator, an estimated joint angle of the whole body of the robot, and an estimated posture of each of the first operation target object and the second target object,
generates a second feature vector by encoding text output by the relationship acquisition unit, and
generates a control command that is a joint angle trajectory sequence of the robot by associating the first feature vector and the second feature vector with each other and encoding associated data.

9. A remote operation control method for operating a robot remote operation of operating a robot by recognizing movement of an operator and transferring the movement of the operator to the robot, the method comprising:
estimating a motion of the operator by the intention estimation unit on the basis of a first sensor value obtained by an environmental sensor acquiring information of the robot or a surrounding environment of the robot, and a second sensor value indicating movement of the operator obtained by an operator sensor;
acquiring a relationship between a first operation target object and a second target object by a relationship acquisition unit; and
generating a control command by a control command generation unit on the basis of an estimated motion of the operator and information acquired by the relationship acquisition unit.

10. A computer-readable non-transitory storage medium storing a program for causing a computer of a remote operation control device, which performs a robot remote operation of operating a robot by recognizing movement of an operator and transferring the movement of the operator to the robot,
to estimate a motion of the operator on the basis of a first sensor value obtained by an environmental sensor acquiring information of the robot or a surrounding environment of the robot, and a second sensor value indicating movement of the operator obtained by an operator sensor,
to acquire a relationship between a first operation target object and a second target object, and
to generate a control command on the basis of an estimated motion of the operator and acquired information of the relationship between the first operation target object and the second target object.
